(19) United States
(12) Patent Application Publication
(10) Pub. No.: US 2005/0064130 A1
(43) Pub. Date: Mar. 24, 2005

(54) Nonlinear optical element, electro-optic element, and compound

(76) Inventor: Naoyuki Nishikawa, Kanagawa (JP)

Correspondence Address: TAIYO CORPORATION, 2111 JEFFERSON DAVIS HIGHWAY, #412, NORTH, ARLINGTON, VA, 22202, US

(21) Appl. No.: 10/921,995

(22) Filed: Aug. 20, 2004

(30) Foreign Application Priority Data
Aug. 26, 2003 (JP) 2003-300808

(51) Int. Cl. B32B 3/02

(52) U.S. Cl. 428/64.4

(57) ABSTRACT

The present invention relates to a nonlinear optical material or an electro-optic material and which is suited for manufacturing nonlinear optical elements or electro-optic elements.
The nonlinear optical or electro-optic material is represented by Formula (I): 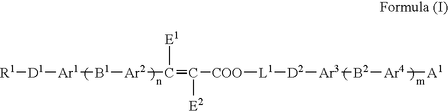
wherein Ar¹, Ar², Ar³, Ar⁴, E¹, E², A¹, B¹, B², m, n, D¹, D², R¹, and L¹ are defined in the specification respectively.

### CROSS-REFERENCE TO RELATED APPLICATION

This application claims priority under 35 USC 119 from Japanese Patent Application, No.2003-300808 the disclosure of which is incorporated by reference herein.

### BACKGROUND OF THE INVENTION

1. Field of the Invention

The present invention relates to a nonlinear optical material and an electro-optic material which are novel and useful in the fields of optoelectronics and photonics, in addition, a nonlinear optical element and an electro-optic element comprising the nonlinear optical material or an electro-optic material.

2. Description of the Related Art

Nonlinear optical effects are phenomena which are caused by the application of a strong electric field (a photoelectric field) to a substance and exhibit a nonlinear relationship between the generated electric polarization and the applied electric field. Nonlinear optical materials refer to materials which significantly exhibit such nonlinearity. Known examples of the nonlinear optical material for the application of a quadratic nonlinear response include second harmonic-generating materials and Pockels effect (primary electro-optic effect)-producing materials which cause a change in refractive index in linear proportion to an electric field. In particular, the latter materials have been investigated for application to electro-optic (EO) optical modulators and photo-refractive elements.

Concerning these nonlinear optical materials, conventionally, nonlinear inorganic materials have mainly been searched for and used to form elements. In recent years, however, attention has been focused on organic materials, because (1) they exhibit high nonlinearity, (2) their response rate is high, (3) they have high optical damage thresholds, (4) a variety of molecules can be designed, and (5) they can have high production suitability.

In order to produce the quadratic nonlinear optical effect, a crystal serving as an aggregate thereof, has to be lacking an inversion symmetry center. Conventionally, a variety of techniques have been examined for the control of the crystal structure. Known examples of such techniques include (1) a method including the steps of introducing an asymmetric carbon into a molecule and growing a crystal using an enantiomer thereof, (2) a method of introducing a sterically hindering substituent into a molecule and (3) a method of using a hydrogen bond between molecules. These methods, however, do not always produce the inversion symmetry-lacking structure and have required the production of a crystal suited for elements or improvement of the workability of the produced crystal.

In the other hand, a caffeic acid derivative represented by the following formula and a pharmaceutically acceptable salt thereof are known as a 12-lipoxygenase inhibitor as disclosed in European Patent No. 475214 and the Journal of Medicinal Chemistry, 34, p. 1503, 1991.

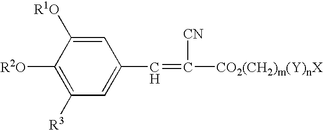

In the formula, one of R¹ and R² independently represents a hydrogen atom, a C1 to C6 alkyl group, —CO₂R⁴ (wherein R⁴ represents a C1 to C12 alkyl group, a C6 to C10 aryl group, a hydrogen atom, or a C7 to C12 aralkyl group), or —CONR⁵R⁶ (wherein R⁵ represents a C1 to C6 alkyl group and R⁶ represents a hydrogen atom or a C1 to C6 alkyl group), while the other of R¹ and R² independently represents —CO₂R⁴ or —CONR⁵R⁶, or R¹ and R² form a five-membered ring; Y represents vinylene group, an oxygen atom or a sulfur atom; X represents an optionally substituted C6 to C 10 aryl group, an optionally substituted C7 to C12 aralkyl group, an optionally substituted heterocyclic group, or an optionally substituted heterocyclic ring-alkyl group; m represents a number from 0 to 8; n represents 0 or 1; and R³ represents a hydrogen atom, a hydroxyl group, —OCO₂R⁷ (wherein R⁷ has the same meaning as R⁴), or —OCONR⁸R⁹ (wherein R⁸ represents a C1 to C6 alkyl group and R⁹ represents a hydrogen atom or a C1 to C6 alkyl group).

The disclosed compounds, however, are all different in structure and use from the compound according to the invention and do not specifically suggested the invention.

### SUMMARY OF THE INVENTION

The present invention has been made in view of the above circumstances and provides a nonlinear optical material or an electro-optic material, and compounds which are suitable for a nonlinear optical material or an electro-optic material.

The inventors have found that the compound represented by the following Formula (I) is effect and thus have made the invention as described below. The compound disclosed in European Patent No. 475214 etc. is different in structure and application from the compound represented by the following Formula (I), and does not specifically suggest the invention.

A first aspect of the invention is to provide a nonlinear optical element comprising a layer that contains the compound represented by Formula (I): 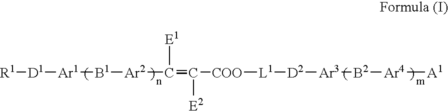
wherein Ar¹, Ar², Ar³, and Ar⁴ each independently represent a five- or six-membered aromatic ring, a five- or six-membered heterocyclic aromatic ring, or a condensed ring thereof, and wherein the rings may have a substituent or substituents; E¹ represents a hydrogen atom or an electron-attracting group; E² represents an electron-attracting group; A¹ represents a hydrogen atom or an electron-attracting group; B¹ and B² each independently represent a single bond, —CH═CH—, —C≡C—, —N═N—, *—COO—, or *—COS—, wherein a bond marked by * is on the left side in Formula (I); m and n each independently represent 1 or 2; D¹ represents an oxygen atom, a sulfur atom or —NR²—; R¹ and R² each independently represent a hydrogen atom or an alkyl group having 1 to 20 carbon atoms and R¹ and R² may be coupled to each other to form a ring; L¹ represents a bivalent linking group; D² represents an oxygen atom, a sulfur atom or —NR³—; R³ represents a hydrogen atom or an alkyl group having 1 to 20 carbon atoms; L¹ and R³ may be coupled to each other to form a ring; and R¹, R², R³, and L¹ may each independently have a substituent or substituents.

A second aspect of the invention is to provide an electro-optic element comprising a layer that contains the compound represented by Formula (I): 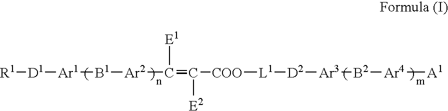
wherein Ar¹, Ar², Ar³, and Ar⁴ each independently represent a five- or six-membered aromatic ring, a five- or six-membered heterocyclic aromatic ring, or a condensed ring thereof, wherein the rings may have a substituent or substituents; E¹ represents a hydrogen atom or an electron-attracting group; E² represents an electron-attracting group; A¹ represents a hydrogen atom or an electron-attracting group; B¹ and B² each independently represent a single bond, —CH═CH—, —C≡C—, —N═N—, *—COO—, or *—COS—, wherein a bond marked by * is on the left side in Formula (I); m and n each independently represent 1 or 2; D¹ represents an oxygen atom, a sulfur atom or —NR²—; R¹ and R² each independently represent a hydrogen atom or an alkyl group having 1 to 20 carbon atoms and R¹ and R² may be coupled to each other to form a ring; L¹ represents a bivalent linking group; D² represents an oxygen atom, a sulfur atom or —NR³—; R³ represents a hydrogen atom or an alkyl group having 1 to 20 carbon atoms; L¹ and R³ may be coupled to each other to form a ring; and R¹, R², R³, and L¹ may each independently have a substituent or substituents.

A third aspect of the invention is to provide a compound represented by Formula (II): 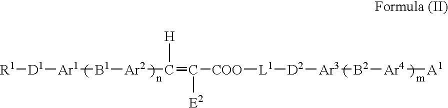
wherein Ar¹, Ar², Ar³, and Ar⁴ each independently represent a five- or six-membered aromatic ring, a five- or six-membered heterocyclic aromatic ring, or a condensed ring thereof, wherein the rings may have a substituent or substituents; E² represents an electron-attracting group having a σp value of 0.2 to 1.2; A¹ represents a hydrogen atom or an electron-attracting group having a σp value of 0.2 to 1.2; B¹ and B² each independently represent a single bond, —CH═CH—, —C≡C—, —N═N—, *—COO—, or *—COS—, wherein a bond marked by * is on the left side in Formula (II); m and n each independently represent 1 or 2; D¹ represents an oxygen atom, a sulfur atom or —NR²—; R¹ and R² each independently represent a hydrogen atom or an alkyl group having 1 to 20 carbon atoms and R¹ and R² may be coupled to each other to form a ring; L¹ represents an alkylene group having 1 to 20 carbon atoms; D² represents an oxygen atom, a sulfur atom or —NR³—; R³ represents a hydrogen atom or an alkyl group having 1 to 20 carbon atoms; L¹ and R³ may be coupled to each other to form a ring; and R¹, R^{2,} R³, and L¹ may each independently have a substituent or substituents.

The compound provided according to the invention can be suitable as a nonlinear optical material or an electro-optic material. A nonlinear optical material having high nonlinear optical properties and an electro-optic material having an electro-optic effect can also easily be provided according to the invention.

### BRIEF DESCRIPTION OF THE DRAWINGS

FIG. 1 is a plot of second harmonic intensities determined by Maker fringe method with respect to quartz and a nonlinear optical element produced in Example 5 according to the invention (in the cases of an incident p-polarized laser beam and an incident s-polarized laser beam).

FIG. 2 is a plot of second harmonic intensities determined by Maker fringe method with respect to quartz and a nonlinear optical element produced in Example 6 according to the invention (in the cases of an incident p-polarized laser beam and an incident s-polarized laser beam).

### DETAILED DESCRIPTION OF THE INVENTION

As other aspects of the invention, fourth to twenty-seventh aspects will be described below.

A fourth aspect of the invention is to provide a nonlinear optical element of the first aspect, wherein the electron-attracting group represented by A¹ is —CN, —NO₂, —C═C(CN)₂, —C═C(CN)COO—R⁴, —COO—R⁴, or —SO₂—R⁴, wherein R⁴ represents an alkyl group having 1 to 20 carbon atoms, and the alkyl group may have a hydroxyl group, an amino group, an ester group, an amide group, an ether group, an alkyl group having 1 to 6 carbon atoms, an alkoxy group having 1 to 6 carbon atoms, or a halogen atom.

A fifth aspect of the invention is to provide a nonlinear optical element of the first aspect, wherein B¹ and B² are each independently a single bond, —C≡C— or —N═N—.

A sixth aspect of the invention is to provide a nonlinear optical element of the fourth aspect, wherein B¹ and B² are each independently a single bond, —C≡C— or —N═N—.

A seventh aspect of the invention is to provide a nonlinear optical element of the first aspect, wherein E² is an electron-attracting group having a sp value of 0.2 to 1.2.

A eighth aspect of the invention is to provide a nonlinear optical element of the first aspect, wherein E¹ is hydrogen.

A ninth aspect of the invention is to provide a nonlinear optical element of the fourth aspect, wherein E¹ is hydrogen.

A tenth aspect of the invention is to provide a nonlinear optical element of the fifth aspect, wherein E¹ is hydrogen.

A eleventh aspect of the invention is to provide a nonlinear optical element of the seventh aspect, wherein E¹ is hydrogen.

A twelfth aspect of the invention is to provide a nonlinear optical element of the first aspect, wherein Ar¹, Ar², Ar³ and Ar⁴ each independently represent a five- or six-membered aromatic ring, a five- or six-membered heterocyclic aromatic ring, or a condensed ring thereof, and wherein the rings are unsubstituted.

An thirteenth aspect of the invention is to provide a electro-optic element of the second aspect, wherein the electron-attracting group represented by A¹ is —CN, —NO₂, —C═C(CN)₂, —C═C(CN)COO—R⁴, —COO—R⁴, or —SO₂—R⁴, wherein R⁴ represents an alkyl group having 1 to 20 carbon atoms, and the alkyl group may have a hydroxyl group, an amino group, an ester group, an amide group, an ether group, an alkyl group having 1 to 6 carbon atoms, an alkoxy group having 1 to 6 carbon atoms, or a halogen atom.

A fourteenth aspect of the invention is to provide an electro-optic element of the second aspect, wherein B¹ and B² are each independently a single bond, —C≡C— or —N═N—.

A fifteenth aspect of the invention is to provide an electro-optic element of the thirteenth aspect, wherein B¹ and B² are each independently a single bond, —C≡C— or —N═N—.

A sixteenth aspect of the invention is to provide an electro-optic element of the second aspect, wherein E² is an electron-attracting group having a sp value of 0.2 to 1.2.

A seventeenth aspect of the invention is to provide an electro-optic element of the second aspect, wherein E¹ is hydrogen.

A eighteenth aspect of the invention is to provide an electro-optic element of the thirteenth aspect, wherein E¹ is hydrogen.

A nineteenth aspect of the invention is to provide an electro-optic element of the fourteenth aspect, wherein E¹ is hydrogen.

A twentieth aspect of the invention is to provide an electro-optic element of the sixteenth aspect, wherein E¹ is hydrogen.

A twenty-first aspect of the invention is to provide an electro-optic element of the second aspect, wherein Ar¹, Ar², Ar³ and Ar⁴ each independently represent a five- or six-membered aromatic ring, a five- or six-membered heterocyclic aromatic ring, or a condensed ring thereof, and wherein the rings are unsubstituted.

A twenty-second aspect of the invention is to provide a compound of the third aspect, wherein the compound represented by Formula (II) is also represented by the following Formula (III): 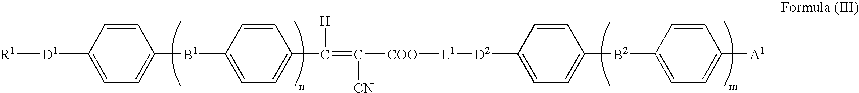
wherein A¹ has the same meaning as defined in Formula (II); the four benzene rings may have a substituent or substituents, wherein the substituents on the benzene rings may be the same or different; and B¹, B², m, n, R¹, R², L¹, D¹, and D² each have the same meaning as defined in Formula (II).

A twenty-third aspect of the invention is to provide a compound of the third aspect, wherein the electron-attracting group represented by A¹ is —CN, —NO₂, —C═C(CN)₂, —C═C(CN)COO—R⁴, —COO—R⁴, or —SO₂—R⁴, wherein R⁴ represents an alkyl group having 1 to 20 carbon atoms, and the alkyl group may have a hydroxyl group, an amino group, an ester group, an amide group, an ether group, an alkyl group having 1 to 6 carbon atoms, an alkoxy group having 1 to 6 carbon atoms, or a halogen atom.

A twenty-fourth aspect of the invention is to provide a compound of the twenty-second aspect, wherein the electron-attracting group represented by A¹ is —CN, —NO₂, —C═C(CN)₂, —C═C(CN)COO—R⁴, —COO—R⁴, or —SO₂—R⁴, wherein R⁴ represents an alkyl group having 1 to 20 carbon atoms, and the alkyl group may have a hydroxyl group, an amino group, an ester group, an amide group, an ether group, an alkyl group having 1 to 6 carbon atoms, an alkoxy group having 1 to 6 carbon atoms, or a halogen atom.

A twenty-fifth aspect of the invention is to provide a compound of the third aspect, wherein B¹ and B² are each independently a single bond, —C≡C— or —N═N—.

A twenty-sixth aspect of the invention is to provide a compound of the twenty-second aspect, wherein B¹ and B² are each independently a single bond, —C≡C— or —N═N—.

A twenty-seventh aspect of the invention is to provide a compound of the third aspect, wherein Ar¹, Ar², Ar³ and Ar⁴ each independently represent a five- or six-membered aromatic ring, a five- or six-membered heterocyclic aromatic ring, or a condensed ring thereof, and wherein the rings are unsubstituted.

In the description, the wording “nonlinear optical material (electro-optic material) represented by Formula (I)” may also imply an aspect in which the compound is contained in a polymerized state, such as an aspect in which the compound is polymerized by light, heat or the like or polymerized with any other compound. The wording “layer that contains the nonlinear optical material (electro-optic material) represented by Formula (I)” means a layer that contains the nonlinear optical material (electro-optic material) represented by Formula (I) and/or a polymer thereof and is formed with the material and/or the polymer, wherein the layer may be in any shape and corresponds to a part containing the material and/or the polymer.

First, a description is provided of the compound represented by Formula (I) below for use as or in the nonlinear optical material or the electro-optic material according to the present invention.

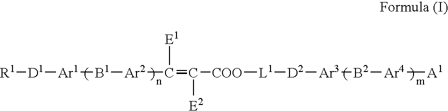

In Formula (I), Ar¹, Ar², Ar³, and Ar⁴ each independently represent a five- or six-membered aromatic ring, a five- or six-membered heterocyclic aromatic ring, or a condensed ring thereof and may have a substituent or substituents; E¹ represents a hydrogen atom or an electron-attracting group; E² represents an electron-attracting group; A¹ represents a hydrogen atom or an electron-attracting group; B¹ and B² each independently represent a single bond, —CH═CH—, —C≡C—, —N═N—, *—COO—, or *—COS—, wherein the bond marked by * is on the left side in Formula (I); m and n each independently represent 1 or 2; D¹ represents an oxygen atom, a sulfur atom or —NR²—; R¹ and R² each independently represent a hydrogen atom or an alkyl group of 1 to 20 carbon atoms. R¹ and R² may be bonded to each other to form a ring; L¹ represents a bivalent linking group; D² represents an oxygen atom, a sulfur atom or —NR³—; R³ represents a hydrogen atom or an alkyl group having 1 to 20 carbon atoms; L¹ and R³ may be bonded to each other to form a ring; and R¹, R², R³, and L¹ may each independently have a substituent or substituents.

In Formula (I), Ar¹, Ar², Ar³, and Ar⁴ each independently represent a five- or six-membered aromatic ring, a five- or six-membered heterocyclic aromatic ring, or a condensed ring thereof. Preferred examples thereof include a benzene ring, a thiophene ring and a naphthalene ring, and the benzene ring is particularly preferred. The ring may be bonded at any position. For example, a six-membered ring such as a benzene ring is preferably coupled at positions 1 and 4, and a five-membered ring such as a thiophene ring is preferably coupled at positions 2 and 5. Ar¹, Ar², Ar³, and Ar⁴ may each independently have a substituent or substituents. Preferred examples of such a substituent include methyl, ethyl, methoxyl, ethoxyl, trifluoromethyl, and a halogen atom. Particularly preferred is methyl, methoxyl, a chloro group, or a bromo group.

E¹ represents a hydrogen atom or an electron-attracting group, preferably a hydrogen atom. When E¹ is the electron-attracting group, having a positive Hammett σp value may be used as a criterion for the electron-attracting properties. Such a σp value is preferably from 0.2 to 1.2, more preferably from 0.3 to 1.1. The Hammett σp value may be determined with reference to Chem. Rev. Vol. 91, p. 165, 1991. Preferred examples thereof include —CN (σp=0.66) and —NO₂ (σp=0.78).

E² represents an electron-attracting group, and having a positive Hammett σp value may be used as a criterion for the electron-attracting properties as shown above. Such a σp value is preferably from 0.2 to 1.2, more preferably from 0.3 to 1.1. Preferred examples thereof include —CN (σp=0.66), —NO₂ (σp=0.78), —COO—R⁴ (for example, σp is 0.45, where R⁴ is CH₃), and —SO₁—R⁴ (for example, σp is 0.72, where R⁴ is CH₃), wherein R⁴ represents an alkyl group having 1 to 20 carbon atoms, and the alkyl group may have a hydroxyl group, an amino group, an ester group, an amide group, an ether group, an alkyl group having 1 to 6 carbon atoms, an alkoxy group having 1 to 6 carbon atoms, or a halogen atom.

A¹ represents a hydrogen atom or an electron-attracting group, and having a positive Hammett σp value may be used as a criterion for the electron-attracting properties as shown above. Such a σp value is preferably from 0.2 to 1.2, more preferably from 0.3 to 1.1. Preferred examples thereof include —CN, —NO₂, —C═C(CN)₂, —C═C(CN)—COO—R⁴, —COO—R⁴, and —SO₂—R⁴, wherein R⁴ represents an alkyl group having 1 to 20 carbon atoms, and the alkyl group may have a hydroxyl group, an amino group, an ester group, an amide group, an ether group, an alkyl group having 1 to 6 carbon atoms, an alkoxy group having 1 to 6 carbon atoms, or a halogen atom, and R⁴ preferably has 4 to 16 carbon atoms, more preferably 4 to 12 carbon atoms.

For example, B¹ or B² is preferably a single bond, —CH═CH—, —C≡C—, or —N═N—, particularly preferably a single bond, —C≡C— or —N═N—.

D¹ is preferably an oxygen atom or —NR²—, particularly preferably —NR²—.

R¹ and R² each independently represents a hydrogen atom or an alkyl group of 1 to 20 carbon atoms and preferably has 4 to 16 carbon atoms, more preferably 4 to 12 carbon atoms. When R¹ and R² are bonded to each other to form a ring, they preferably form a pyrrolidine ring or a piperidine ring.

L¹ is a bivalent linking group, preferably an alkylene group having 1 to 20 carbon atoms, more preferably an alkylene group having 4 to 16 carbon atoms.

D² is preferably an oxygen atom or —NR³—. R³ is preferably an alkyl group having 1 to 6 carbon atoms, particularly preferably methyl or ethyl. When L¹ and R³ are bonded to each other to form a ring, they preferably form a pyrrolidine ring or a piperidine ring.

R¹, R², R³, and L¹ may each independently have a substituent or substituents. Preferred examples of such a substituent include a hydroxyl group, an amino group, an ester group, an amide group, an ether group, an alkyl group having 1 to 6 carbon atoms, an alkoxy group having 1 to 6 carbon atoms, a halogen atom, and a group comprising any combination thereof.

Formula (II) is described in detail below.

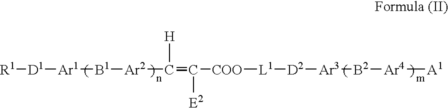

In Formula (II), Ar¹, Ar², Ar³, and Ar⁴ each independently represent a five- or six-membered aromatic ring, a five- or six-membered heterocyclic aromatic ring, or a condensed ring thereof and may have a substituent or substituents; E² represents an electron-attracting group having a σp value of 0.2 to 1.2; A¹ represents a hydrogen atom or an electron-attracting group having a σp value of 0.2 to 1.2; B¹ and B² each independently represent a single bond, —CH═CH—, —C≡C—, —N═N—, *—COO—, or *—COS—, wherein the bond marked by * is on the left side in Formula (II); m and n each independently represent 1 or 2; D¹ represents an oxygen atom, a sulfur atom or —NR²—; R¹ and R² each independently represent a hydrogen atom or an alkyl group having 1 to 20 carbon atoms or R¹ and R² may be coupled to each other to form a ring; L¹ represents an alkylene group having 1 to 20 carbon atoms; D² represents an oxygen atom, a sulfur atom or —NR³—; R³ represents a hydrogen atom or an alkyl group having 1 to 20 carbon atoms; L¹ and R³ may be bonded to each other to form a ring; and R¹, R², R³, and L¹ may each independently have a substituent or substituents.

In Formula (II), Ar¹, Ar², Ar³, and Ar⁴ each independently represent a five- or six-membered aromatic ring, a five- or six-membered heterocyclic aromatic ring, or a condensed ring thereof. Preferred examples thereof include a benzene ring, a thiophene ring and a naphthalene ring, and the benzene ring is particularly preferred. The ring may be coupled at any position. For example, a six-membered ring such as a benzene ring is preferably coupled at positions 1 and 4, and a five-membered ring such as a thiophene ring is preferably coupled at positions 2 and 5. Ar¹, Ar², Ar³, and Ar⁴ may each independently have a substituent or substituents. Preferred examples of such a substituent include methyl, ethyl, methoxyl, ethoxyl, trifluoromethyl, and a halogen atom. Particularly preferred is methyl, methoxyl, a chloro group, or a bromo group.

In terms of a scale for the electron-attracting properties, the Hammett σp value of E² is preferably from 0.2 to 1.2, more preferably from 0.3 to 1.1. Preferred examples thereof include —CN, —NO₂, —COO— R⁴, and —SO₂—R⁴, wherein R⁴ represents an alkyl group having 1 to 20 carbon atoms, and the alkyl group may have a hydroxyl group, an amino group, an ester group, an amide group, an ether group, an alkyl group having 1 to 6 carbon atoms, an alkoxy group having 1 to 6 carbon atoms, or a halogen atom.

A¹ is a hydrogen atom or has a σp value of 0.2 to 1.2, preferably of 0.3 to 1.1 in terms of a scale for the electron-attracting properties. Preferred examples thereof include —CN, —NO₂, —C═C(CN)₂, —C═C(CN)—COO—R⁴, —COO—R⁴, and —SO₂—R⁴, wherein R⁴ represents an alkyl group having 1 to 20 carbon atoms, and the alkyl group may have a hydroxyl group, an amino group, an ester group, an amide group, an ether group, an alkyl group having 1 to 6 carbon atoms, an alkoxy group having 1 to 6 carbon atoms, or a halogen atom, and R⁴ preferably has 4 to 16 carbon atoms, more preferably 4 to 12 carbon atoms.

For example, B¹ or B² is preferably a single bond, —CH═CH—, —C≡C—, or —N═N—, particularly preferably a single bond, —C≡C— or —N═N—.

D¹ is preferably an oxygen atom or —NR²—, particularly preferably —NR²—.

R¹ and R² each independently represents a hydrogen atom or an alkyl group having 1 to 20 carbon atoms and preferably has 4 to 16 carbon atoms, more preferably 4 to 12 carbon atoms. When R¹ and R² are coupled to each other to form a ring, they preferably form a pyrrolidine ring or a piperidine ring.

L¹ is an alkylene group having 1 to 20 carbon atoms, preferably an alkylene group having 4 to 16 carbon atoms.

D² is preferably an oxygen atom or —NR³—. R³ is preferably an alkyl group having 1 to 6 carbon atoms, particularly preferably methyl or ethyl. When L¹ and R³ are bonded to each other to form a ring, they preferably form a pyrrolidine ring or a piperidine ring.

R¹, R², R³, and L¹ may each independently have a substituent or substituents. Preferred examples of such a substituent include a hydroxyl group, an amino group, an ester group, an amide group, an ether group, an alkyl group having 1 to 6 carbon atoms, an alkoxy group having 1 to 6 carbon atoms, a halogen atom, and a group comprising any combination thereof.

A preferred mode of Formula (II) is Formula (III): 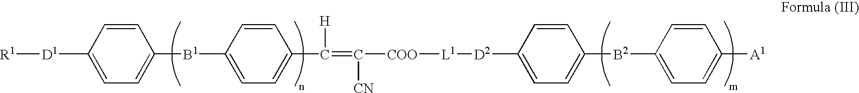
wherein A¹, B¹, B², m, n, D¹, R¹, L¹, and D² each have the same meaning as defined in Formula (II), and preferred examples thereof are also the same. When D¹ is —NR²—, R² has the same meaning as defined in Formula (II), and preferred examples thereof are also the same. When D² is —NR³—, R³ has the same meaning as defined in Formula (II), and preferred examples thereof are also the same.

In Formula (III), any of the benzene rings may have a substituent or substituents. In Formula (III), the four benzene rings may each have a substituent or substituents.

R¹, R², R³, and L¹ may each have a substituent or substituents. Preferred examples of such a substituent include a hydroxyl group, an amino group, an ester group, an amide group, an ether group, an alkyl group having 1 to 6 carbon atoms, an alkoxy group having 1 to 6 carbon atoms, and a halogen atom. Such a substituent may be a group comprising any combination thereof.

Specific examples of the compounds of Formulae (I) to (III) according to the invention include, but are not limited to, the compounds as shown below.

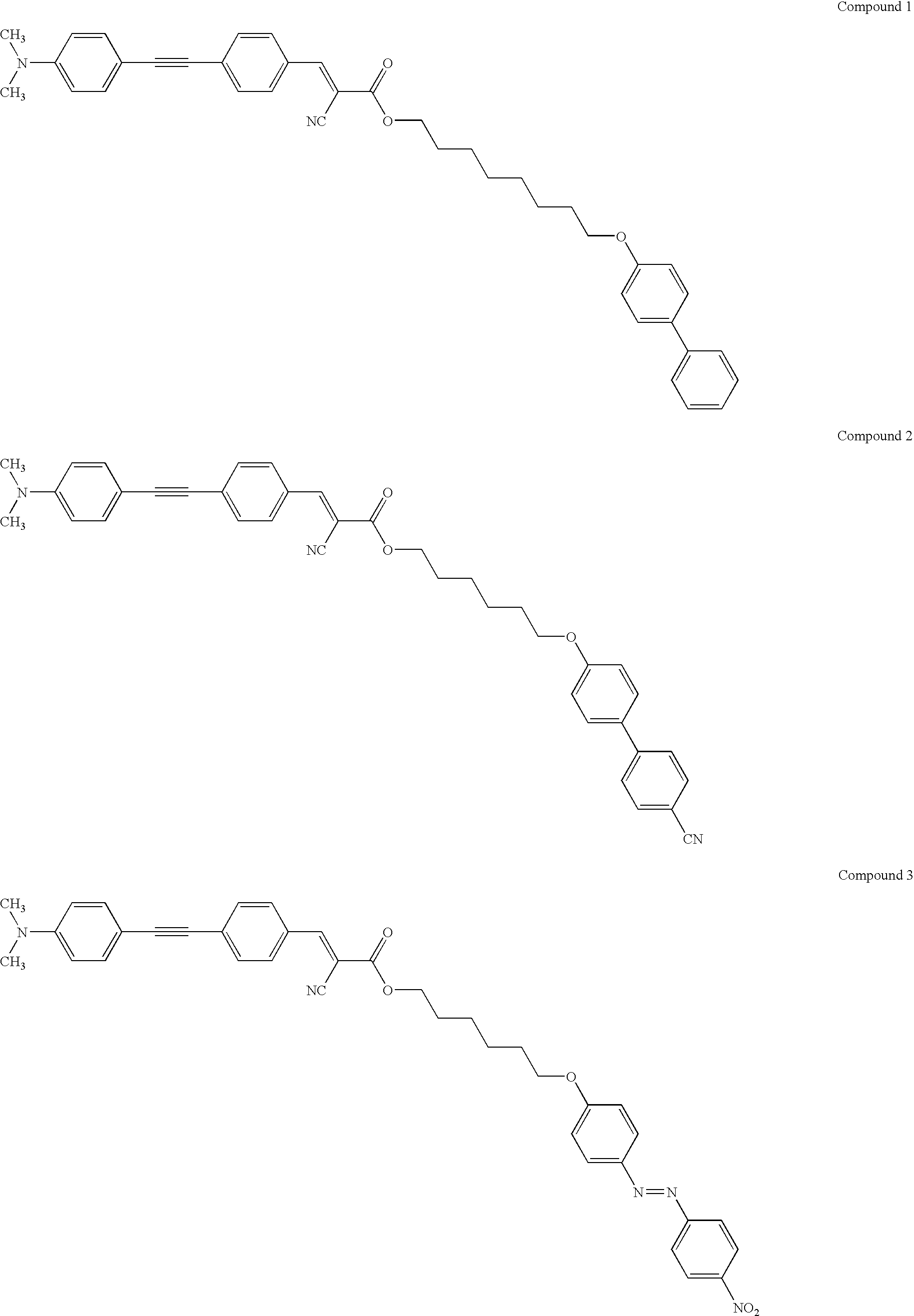

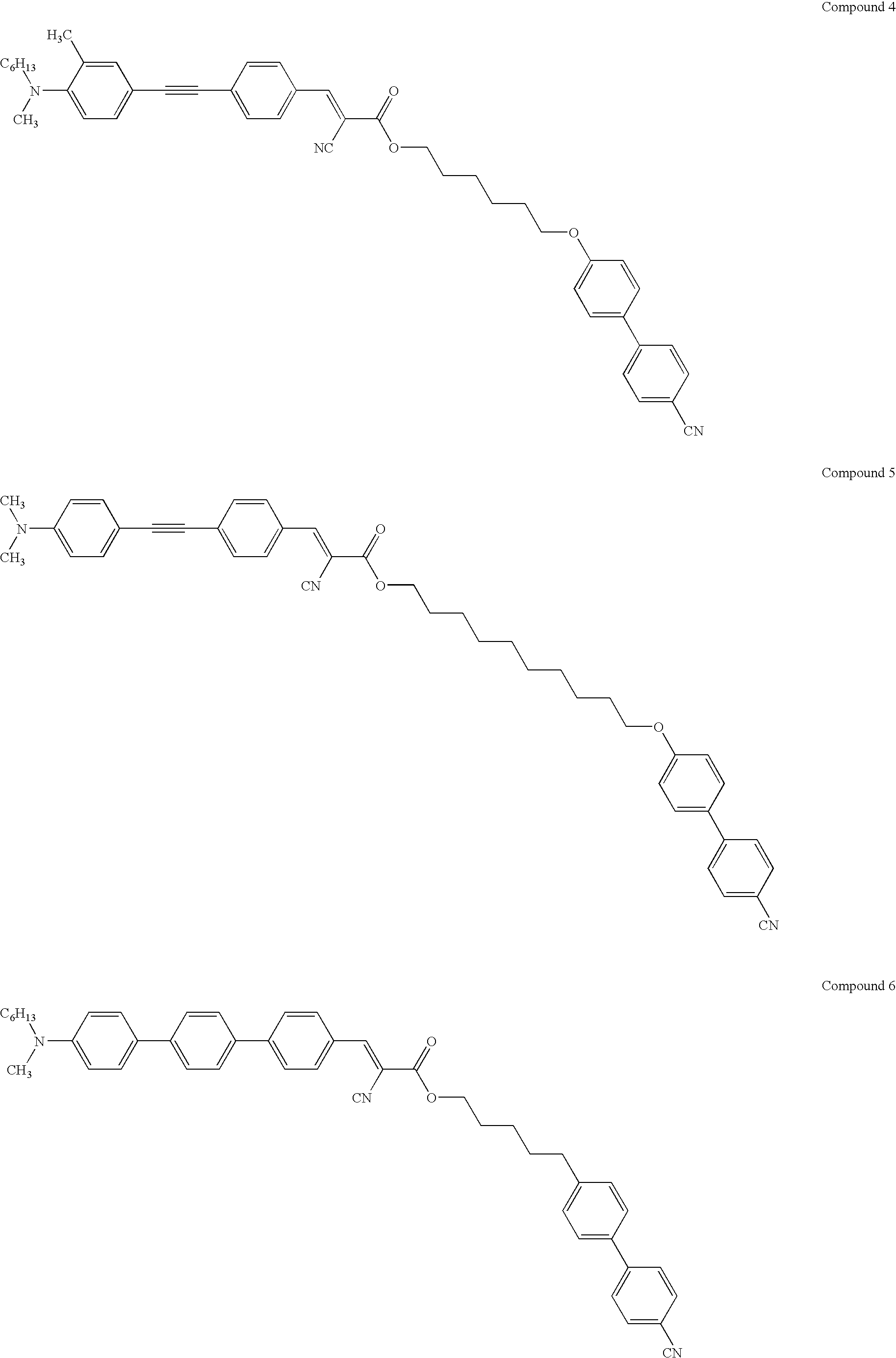

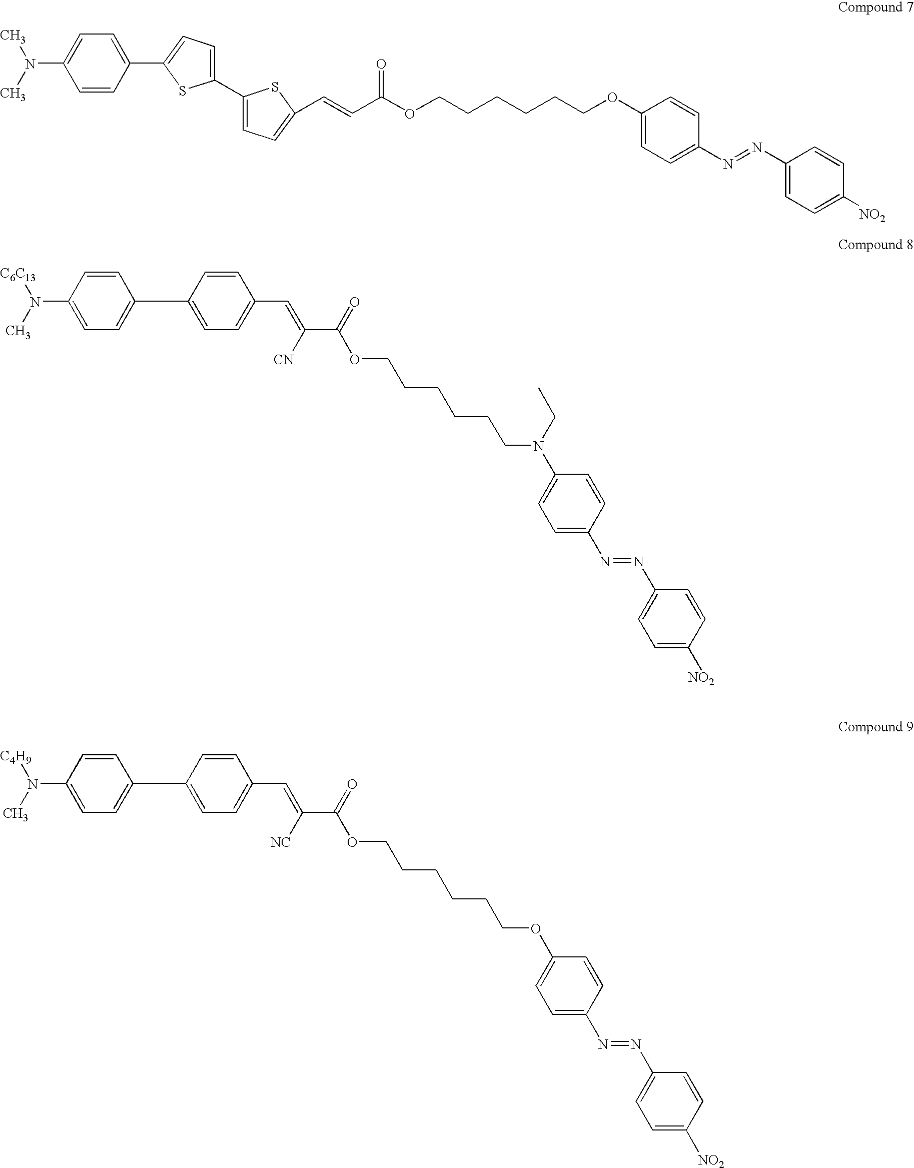

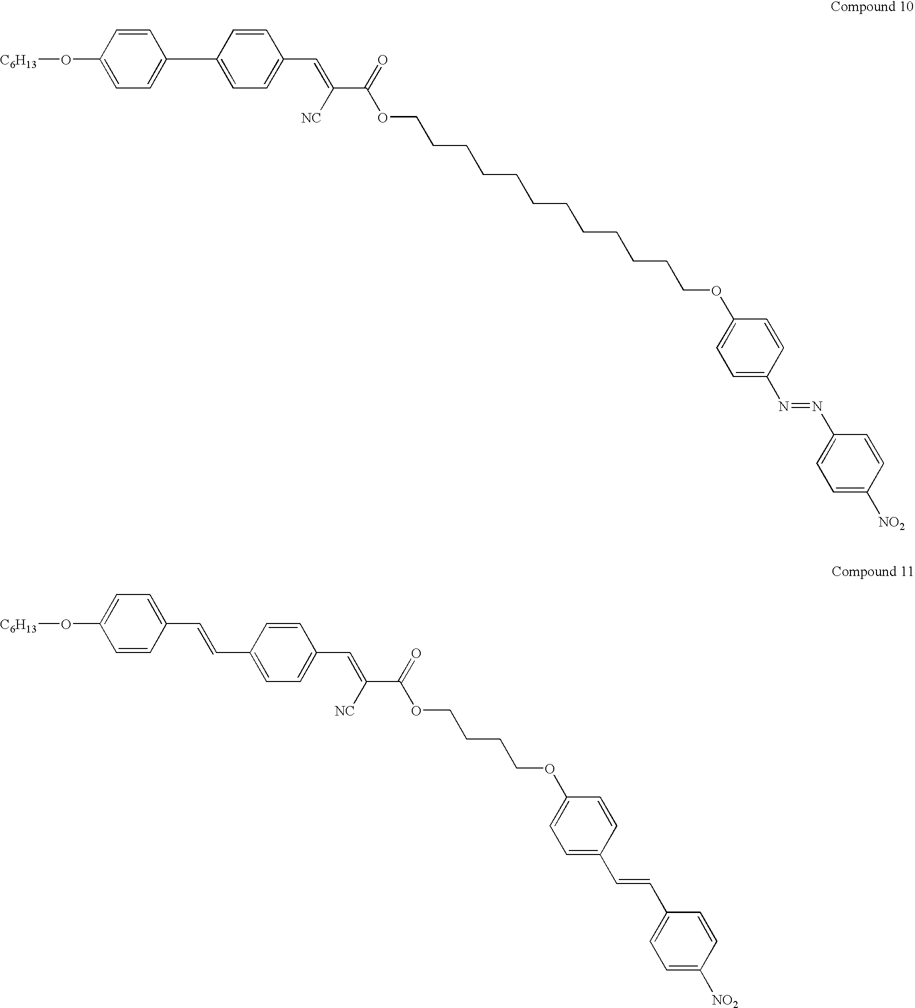

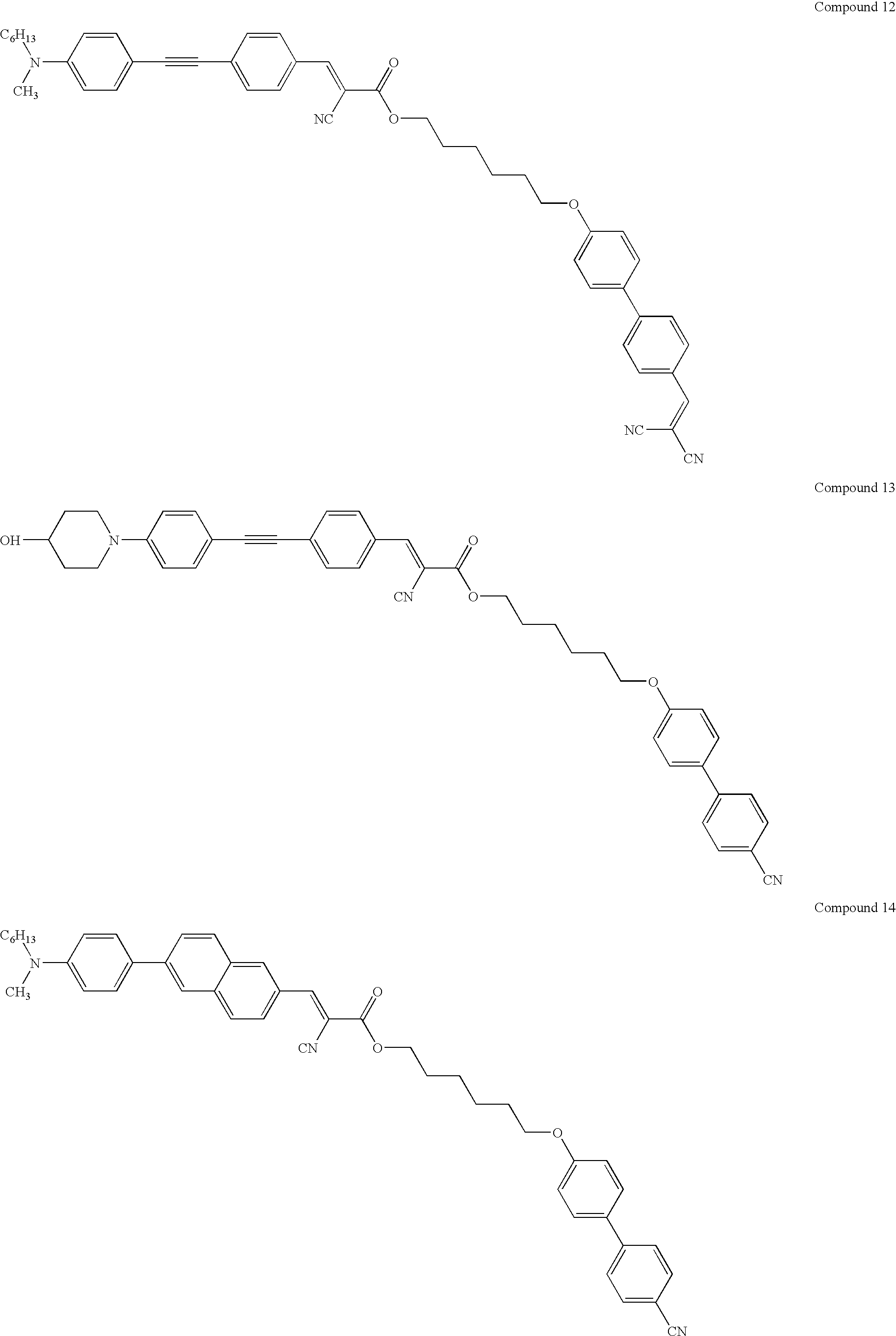

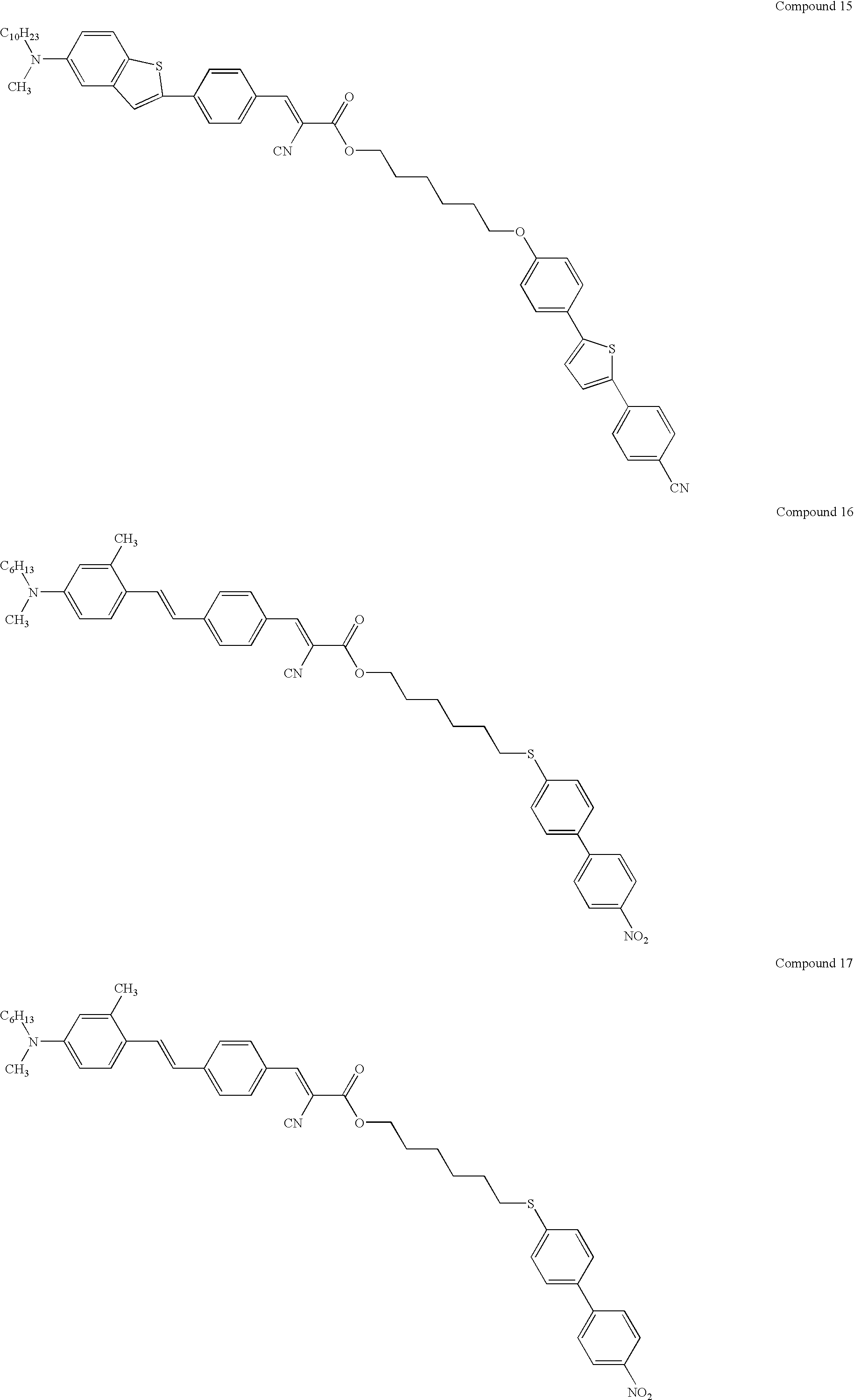

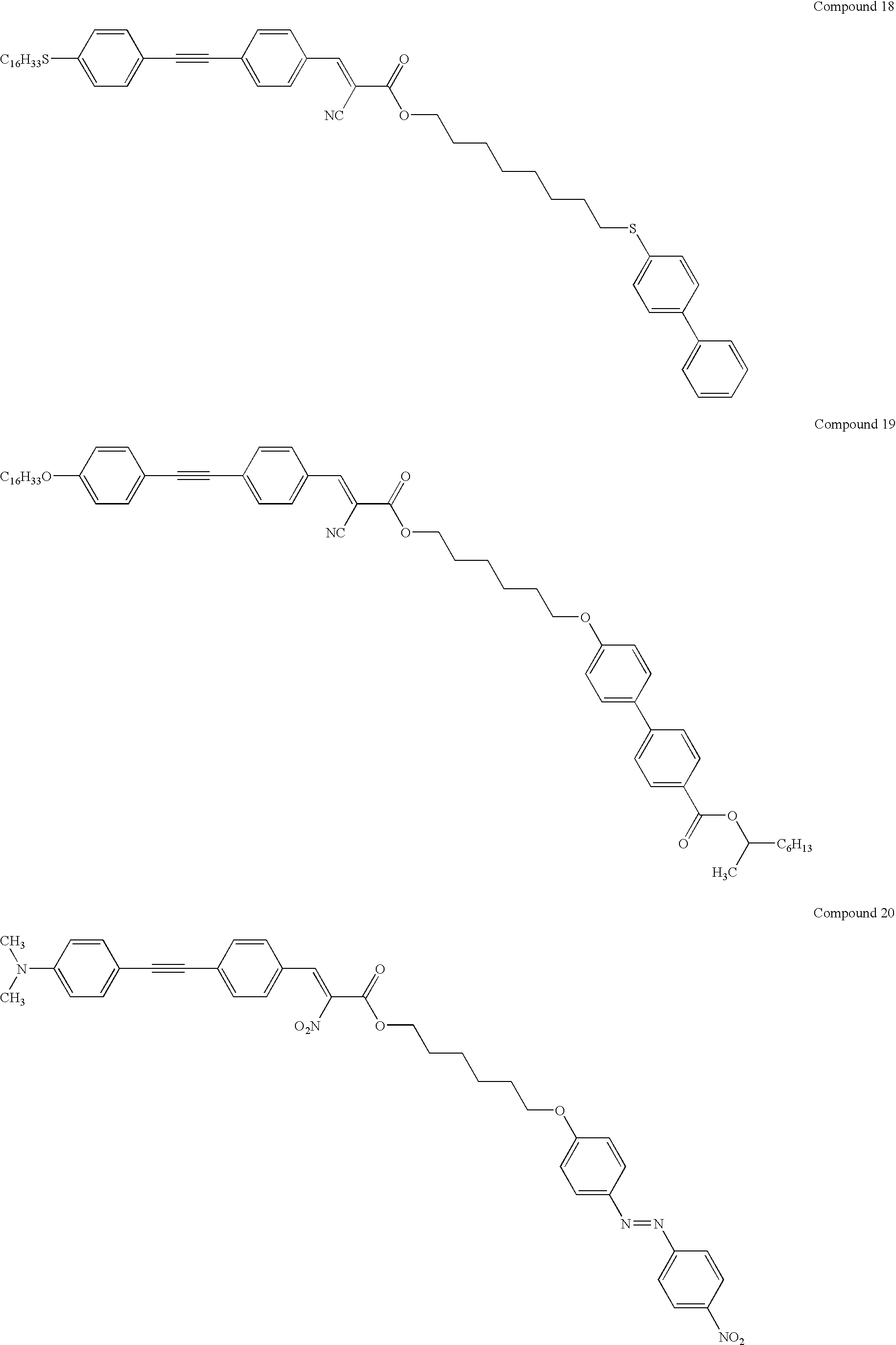

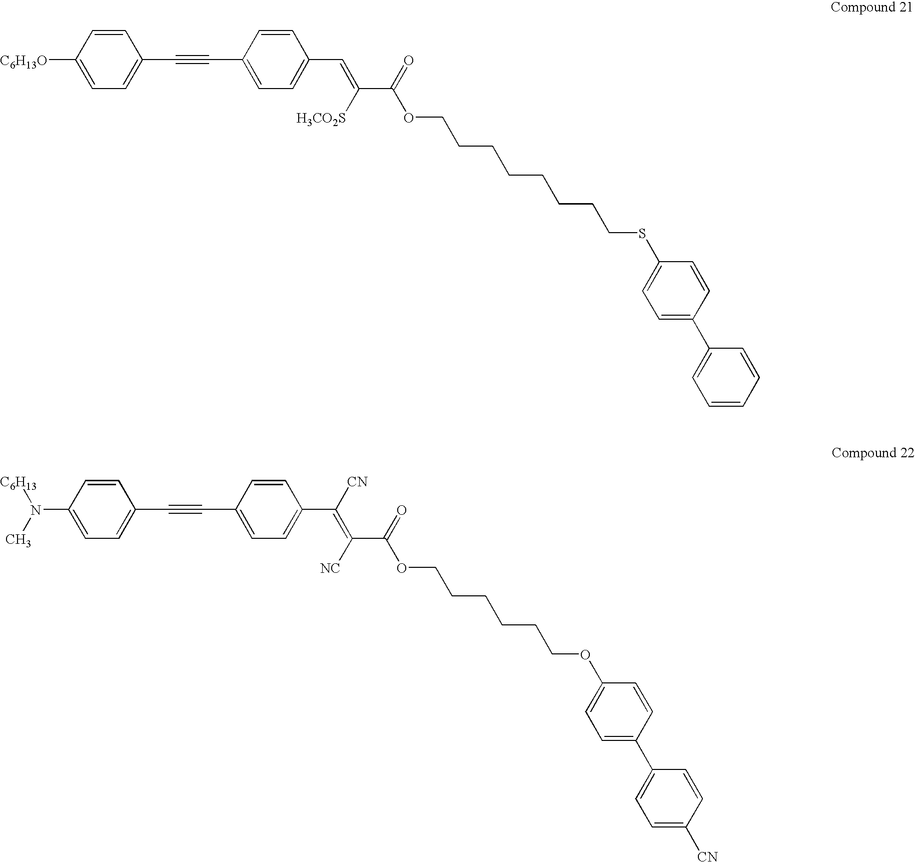

A description is provided below of a method of producing the Formula (I) compound of the invention, but such a method is not intended to limit the scope of the invention. For example, the Formula (I) compound or the Formula (II) compound (where E¹ is H) according to the invention may be synthesized from a starting material compound represented by Formula (C-1) by the method of Reaction Scheme 1: 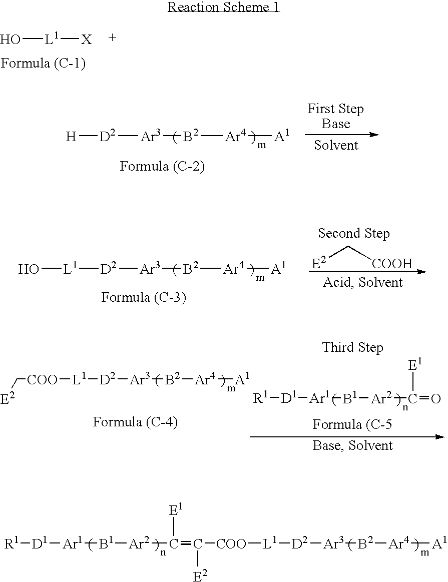
Formula (I) Formula (II) (where E1 is H)
wherein X represents a desorption group.

In the first step, the compound represented by Formula (C-1) and the compound represented by Formula (C-2) are dissolved in a solvent and allowed to react with each other in the presence of a base to form the compound represented by Formula (C-3). In Formula (C-1), X represents a desorption group, preferably a halogen atom, more preferably a chlorine, bromine or iodine atom. In Formulae (C-1) to (C-3), L¹, D², Ar³, B², Ar⁴, and A¹ each have the same meaning as defined in Formulae (I) to (III). The compounds represented by Formulae (C-1) and (C-2), respectively, are commercially available or can be synthesized by a known method.

Acetonitrile, dimethylformamide, dimethylacetamide, or the like is preferably used as the solvent in the first step. Any of an inorganic base and an organic base may be used as the base, but an inorganic base is preferably used, such as potassium carbonate and sodium carbonate. Preferably 0.5 to 10 equivalents of the base, more preferably 2 to 5 equivalents of the base is used based on one equivalent of the compound represented by Formula (C-1). The reaction temperature is generally from room temperature to the boiling point of the solvent for use, preferably from 100° C. to 150° C. or a reflux condition temperature. The reaction time is generally from 10 minutes to one day, preferably from one hour to 12 hours. If necessary, a small amount of sodium iodide or potassium iodide may be added in order to accelerate the reaction.

In the second step, the resulting compound of Formula (C-3) and a carboxylic acid (which is cyanoacetic acid when E² is a cyano group) are allowed to react with each other in the presence of an acid catalyst to form the compound of Formula (C-4), while the by-produced water is removed. E² has the same meaning as defined in Formula (I).

Toluene is preferably used as the solvent in this step. Para-toluenesulfonic acid, mesylic acid (methansulfonic acid) or the like is preferably used as the acid catalyst. Preferably 0.001 to 0.1 equivalents of the acid is used, based on one equivalent of the compound represented by Formula (C-3), and a catalytic amount of the acid is sufficient. The reaction temperature is generally from room temperature to the boiling point of the solvent for use, preferably a reflux condition temperature. The reaction time is generally from 10 minutes to one day, preferably from one hour to 12 hours.

In the third step, the resulting compound of Formula (C-4) and the compound represented by Formula (C-5) are dissolved in a solvent and allowed to react with each other in the presence of a base to form the compound represented by Formula (I) or Formula (II) (where E¹ is H). In this step, R¹, D¹, Ar¹, B¹, and Ar² each have the same meaning as defined in Formulae (I) to (III). The compound represented by Formula (C-5) is commercially available or can be synthesized by a known method.

Any solvent may be used in the third step, and for example, tetrahydrofuran is preferred. Preferred examples of the base for use in this step include amines, and piperidine is particularly preferred. Addition of a catalytic amount of the base should be sufficient, and the base does not always have to be added. The reaction temperature is generally from room temperature to the boiling point of the solvent for use. The reaction time is generally from 10 minutes to one day, preferably from one hour to 12 hours.

In the case that the compound of Formula (I) has a substituent, the above method of producing the compound may include the steps of previously introducing a precursor of the desired substituent and appropriately converting it into the desired substituent. If necessary, the steps of introducing a protective group and removing the protective group may be employed in order to introduce the desired group. The protective group may properly be selected depending on the compound to be protected. The compound of Formula (II) or (III) may also be synthesized using the process of synthesizing the compound of Formula (I).

The nonlinear optical material or electro-optic material of the invention is characterized by comprising at least one of the compounds represented by Formula (I) as a component. One or more of the compounds may be used alone or in combination. When a plurality of the compounds are used, the melting point of the compounds or the liquid-crystal-forming temperature of the compounds can be lowered in some cases. Any additive or the like may also be added to the compound of Formula (I) to form a mixture before use. The compound represented by Formula (I) according to the invention may also be held on a polymer medium or the like to form a nonlinear optical material or an electro-optic material.

When the compound of Formula (I) is used as a component according to the invention, a nonlinear optical material or an electro-optic material is provided which can spontaneously have a polarized orientation or can easily be controlled with respect to polarized orientation and which has good nonlinear optical properties and is suited for manufacturing nonlinear optical elements or electro-optic elements.

For example, the additive may be an aid for lowering the melting point of the compound or for lowering the liquid-crystal-forming temperature of the compound or an aid for stabilizing the compound. Examples of the aid for lowering the melting point or the liquid-crystal-forming temperature of the compound include a liquid crystal compound such as 5CB and an amorphous compound such as triphenylamine. Examples of the aid for stabilizing the compound include various UV absorbers, and a benzophenone type UV absorber or a benzotriazole type UV absorber is preferably used.

Any polymer medium may be used to hold the compound represented by Formula (I) according to the invention. Examples of such a polymer include, but are not limited to, an acrylic polymer such as PMMA, an imide polymer such as fluorinated polyimide, and polycarbonate.

For example, the nonlinear optical element of the invention may be produced by the method as shown below.

The compound according to the invention is sealed in a cell that comprises a pair of transparent substrates and then heated to a temperature at which the compound turns into a liquid. The compound is then cooled to near the liquid-crystal-forming temperature or the melting point (crystallization temperature) and kept at near the temperature until the state of the phase becomes uniform. The compound is then cooled to a temperature equal to or lower than the melting point (crystallization temperature) so that a element having nonlinear optical properties is produced.

In this process, any transparent substrate may be used such as a glass substrate and a polymer substrate such as a polyethylene terephthalate substrate, but is not particularly limited.

Another method of producing the nonlinear optical material element according to the invention may include the steps of: (1) dissolving a composition in a solvent wherein the composition contains the compound represented by Formula (I) according to the invention and a polymer medium that holds the compound; (2) applying the solution of the composition to a support or the like and drying it; and (3) performing an orientation process.

The same polymer medium as used in the above process may be used in the step of dissolving the composition that contains the compound represented by Formula (I) according to the invention and the polymer medium that holds the compound. Examples of such a solvent include, but are not limited to, an ester solvent such as ethyl acetate, a ketone solvent such as methyl ethyl ketone, an ether solvent such as tetrahydrofuran, a halide solvent such as chloroform and dichloromethane, and any mixture thereof.

In the step of the coating, any support may be used, for example, including but not limited to a glass substrate, a polymer film and a reflector plate. Any known method of oating may be used such as curtain coating, extrusion coating, roll coating, spin coating, dip coating, bar coating, spray coating, slide coating, and print coating.

In the orientation process, a corona poling method or a contact poling method may be employed.

For example, the electro-optic element of the invention may be produced by the method as shown below.

The compound according to the invention is sealed in a cell that comprises a pair of transparent substrates each having a transparent electrode layer and then heated to a temperature at which the compound turns into a liquid, similarly to the above process of the nonlinear optical element. The compound is then cooled to near the liquid-crystal-forming temperature or the melting point (crystallization temperature) and kept at near the temperature until the state of the phase becomes uniform. The compound is then cooled to a temperature equal to or lower than the melting point (crystallization temperature) so that an electro-optic element is produced.

According the invention, there is provided a waveguide type electro-optic element comprising: a substrate; a core made from electro-optic material formed on the substrate; cladding layers which are formed on the upper and lower sides of the core and between which the core is sandwiched; and a pair of electrodes for applying an electric field to the core and the upper and lower cladding layers. For example, such a element may be produced by the following method including the steps of:
(1) forming parts of the lower cladding layer and the core;
(2) filling an electro-optic material that comprises the compound represented by Formula (I) according to the invention as a component into the part of the core;
(3) forming a layer for serving as the upper clad;
(4) performing an orientation process; and
(5) installing the electrodes.

Examples of the substrate for use include, but are not limited to, a metal substrate, a silicon substrate, and a transparent substrate. The substrate is appropriately selected depending on the embodiment of the application of the produced material, and the substrate preferably has good flatness. Preferred examples of the metal substrate include a gold substrate, a silver substrate, a copper substrate, and an aluminum substrate. Preferred examples of the transparent substrate include a glass substrate and a plastic substrate.

Examples of the material for forming the cladding layer include, but are not limited to, glass and a polymer material such as PMMA and polyimide.

The orientation process may include the steps of: heating the compound to a temperature at which the compound turns into a liquid; cooling the compound to the liquid-crystal-forming temperature or the melting point (crystallization temperature) and keeping it at near the temperature until the state of the phase becomes uniform; and then cooling it to a temperature equal to or lower than the melting point (crystallization temperature).

In the orientation process, a corona poling method or a contact poling method may also be employed.

Preferred examples of the electrode include an electrode of a metal such as gold, silver, copper, and aluminum and a transparent electrode such as an ITO electrode and a TCO electrode.

### EXAMPLES

The present invention is more specifically described by means of the examples below, which are not intended to limit the scope of the invention.

### Example 1

Production of Compound 1

<First Step>

In 200 ml of dimethylamide were dissolved 17.0 g of 4-hydroxybiphenyl and 20.9 g of 8-bromooctanol, and then 27.8 g of potassium carbonate and 1 g of potassium iodide were added thereto. The mixture was allowed to react at an external temperature of 120° C. for five hours. Water was then poured into the reaction liquid, and the produced precipitate was collected by filtration under reduced pressure. The resulting precipitate was re-crystallized with acetonitrile, giving 28.6 g of 4-(8-hydroxyoctyl)oxybiphenyl.

<Second Step>

The resulting 4-(8-hydroxyoctyl)oxybiphenyl (2.98 g) and 0.85 g of cyanoacetic acid were mixed with 50 ml of toluene and 0.5 g of p-toluenesulfonic acid and stirred. The mixture was heated until reflux conditions were produced, and allowed to react for five hours while the azeotropic water was removed. The reaction liquid was then washed with water, dried with sodium sulfate and then concentrated under reduced pressure. The resulting residue was re-crystallized with acetonitrile, giving a cyanoacetate ester (2.4 g).

<Third Step>

The resulting cyanoacetate ester (0.18 g) and 4-[4-(dimethylaminophenyl)ethynyl]benzaldehyde (0.12 g) were dissolved in 5 ml of THF, and piperidine (three drops) was added thereto. The mixture was stirred for two hours under reflux conditions. The reaction liquid was filtered, and the product separated by the filtration was re-crystallized with acetonitrile, giving 0.21 g of Compound 1. The resulting crystal was determined as being the desired compound by 1H-NMR and Fab-Mass under the conditions below. The results of the measurement are as follows:

Fab Mass (M+H)⁺=597

H1-NMR (δ: CDCl3, TMS, ppm) 1.38-1.58 (m,8H), 1.75-1.85 (m,4H), 3.02 (s,6H), 4.00 (t,2H), 4.32 (t,2H), 6.66 (d,2H), 6.96 (d,2H), 7.25-7.29 (m,1H, with CHCl3 at 7.26), 7.35-7.45 (m,4H), 7.50-7.60 (m,6H), 7.96 (d,2H), 8.20 (s,1H)

### Example 2

Production of Compound 2

<First Step>

In 50 ml of acetonitrile were dissolved 3.9 g of 4-hydroxy-4′-cyanobiphenyl and 2.7 g of 6-chlorohexanol, and then 2.78 g of potassium carbonate and 1.0 g of potassium iodide were added thereto. The mixture was allowed to react for six hours under reflux conditions. Water was then poured into the reaction liquid, and the produced precipitate was collected by filtration under reduced pressure. The resulting precipitate was re-crystallized with acetonitrile, giving 2.3 g of 4-(6-hydroxyhexyl)oxy-4′-cyanobiphenyl.

<Second Step>

The resulting 4-(6-hydroxyhexyl)oxy-4′-cyanobiphenyl (2.3 g) and 0.80 g of cyanoacetic acid were mixed with 50 ml of toluene and 0.5 g of p-toluenesulfonic acid and stirred. The mixture was heated until reflux conditions were produced, and allowed to react for five hours while the azeotropic water was removed. The reaction liquid was then washed with water, dried with sodium sulfate and then concentrated under reduced pressure. The resulting residue was re-crystallized with acetonitrile, giving a cyanoacetate ester (0.8 g).

<Third Step>

The resulting cyanoacetate ester (0.36 g) and 4-[4-(dimethylaminophenyl)ethynyl]benzaldehyde (0.25 g) were dissolved in 3 ml of THF, and piperidine (three drops) was added thereto. The mixture was stirred for five hours under reflux conditions. The reaction liquid was filtered, and the product separated by the filtration was re-crystallized with acetonitrile, giving 0.18 g of Compound 2. The resulting crystal was determined as being the desired compound by 1H-NMR and Fab-Mass under the conditions below. The results of the measurement are as follows:

Fab Mass (M+H)⁺=594

H1-NMR (δ: CDCl3, TMS, ppm) 1.48-1.58 (m,4H), 1.80-1.90 (m,4H), 3.02 (s,6H), 4.03 (t,2H), 4.35 (t,2H), 6.66 (d,2H), 6.99 (d,2H), 7.44 (d,2H), 7.52 (d,2H), 7.56 (d,2H), 7.63 (d,2H), 7.65 (d,2H), 7.95 (d,2H), 8.19 (s,1H)

### Example 3

Production of Compound 3

<First Step>

In 20 ml of dimethylacetamide were dissolved 2.4 g of 4-hydroxy-4′-nitroazobenzene and 1.4 g of 6-chlorohexanol, and then 2.78 g of potassium carbonate and 1.0 g of potassium iodide were added thereto. The mixture was allowed to react at an external temperature of 120° C. for five hours. The reaction liquid was then mixed with water and extracted with ethyl acetate. The liquid extract was dried with magnesium sulfate and then concentrated under reduced pressure. The resulting residue was re-crystallized with acetonitrile, obtaining 3.2 g of 4-(6-hydroxyhexyl)oxy-4′-nitroazobenzene.

<Second Step>

The resulting 4-(6-hydroxyhexyl)oxy-4′-nitroazobenzene (1.4 g) and 0.41 g of cyanoacetic acid were mixed with 100 ml of toluene and 0.34 g of p-toluenesulfonic acid and stirred. The mixture was heated until reflux conditions were produced, and allowed to react for five hours while the azeotropic water was removed. The reaction liquid was then washed with water, dried with sodium sulfate and then concentrated under reduced pressure. The resulting residue was purified by silica gel chromatography (hexane/chloroform/ethyl acetate=1/1/0.3 (V/V/V)), obtaining a cyanoacetate ester (0.5 g).

<Third Step>

The resulting cyanoacetate ester (0.36 g) and 4-[4-(dimethylaminophenyl)ethynyl]benzaldehyde (0.25 g) were dissolved in 3 ml of THF, and piperidine (three drops) was added thereto. The mixture was stirred for two hours under reflux conditions. The reaction liquid was filtered, and the product separated by the filtration was re-crystallized with acetonitrile, obtaining 0.25 g of Compound 3. The resulting crystal was determined as being the desired compound by 1H-NMR and Fab-Mass under the conditions below. The results of the measurement are as follows:

Fab Mass (M+H)⁺=642

H1-NMR (δ: CDCl3, TMS, ppm) 1.48-1.58 (m,4H), 1.80-1.9 (m,4H), 3.02 (s,6H), 4.09 (t,2H), 4.36 (t,2H), 6.66 (d,2H), 7.02 (d,2H), 7.42 (d,2H), 7.56 (d,2H), 7.90-8.00 (m,6H), 8.18 (s,1H), 8.35 (d,2H)

Compounds 4 to 22 may each be synthesized based on the process of Examples 1 to 3.

### Example 5

Production of Nonlinear Optical Element 1

Compound 2 was injected at 220° C. into a liquid-crystal-evaluation cell (with a cell gap of 5 μm, manufactured by E.H.C) comprising a pair of glass substrates. The cell was then cooled to 150° C. and then heated to 160° C. The cell was allowed to stand at 160° C. for three minutes and then cooled to room temperature so that a nonlinear optical element was prepared.

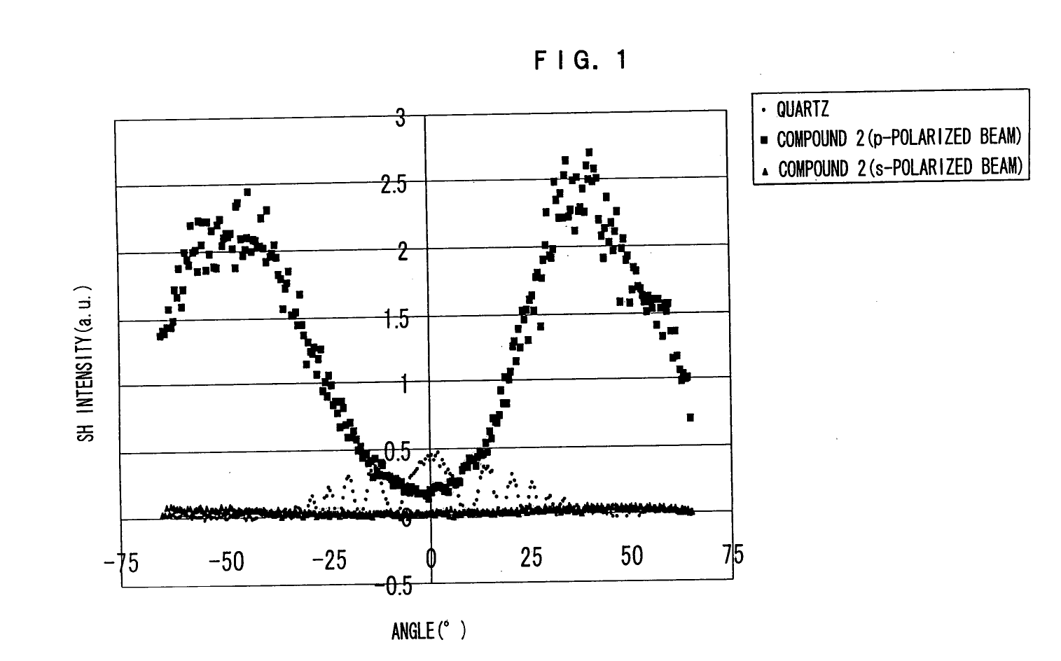

An infrared YHG laser beam (1.06 μm) was applied to the resulting element so that the generation of second harmonic was recognized. Intensity of the second harmonic was measured by the Maker fringe method described in J. Opt. Soc. Am. Vol. B6, p. 733, 1989. The results are shown in FIG. 1. It is apparent from FIG. 1 that when a p-polarized beam is let in from the infrared YHG laser, the maximum value of the second harmonic intensity with respect to the element is about five times larger than that of the reference quartz and that the element has high nonlinear optical properties.

### Example 6

Production of Nonlinear Optical Element 2

A nonlinear optical element was prepared using the process of Example 5 except that Compound 3 was alternatively used.

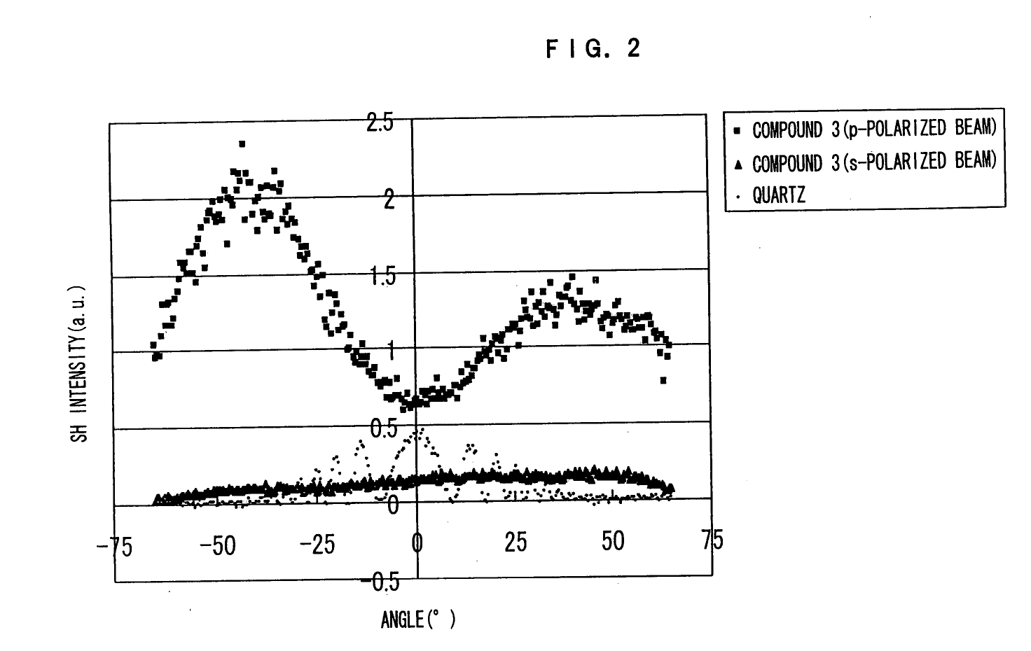

An infrared YHG laser beam (1.06 μm) was applied to the resulting element so that the generation of second harmonic was recognized. The intensity of the second harmonic was measured by the same Maker fringe method as employed in Example 5. The results are shown in FIG. 2. It is apparent from FIG. 2 that when a p-polarized beam is let in from the infrared YHG laser, the maximum value of the second harmonic intensity with respect to the element is about four times larger than that of the reference quartz and that the element has high nonlinear optical properties.

### Example 7

Production of Electro-Optic Element 1

Compound 2 was injected at 220° C. into a liquid-crystal-evaluation cell (with a cell gap of 5 μm, manufactured by E.H.C) comprising a pair of glass substrates each having a transparent electrode layer. The cell was then cooled to 150° C. and then heated to 160° C. The cell was allowed to stand at 160° C. for three minutes and then cooled to room temperature so that an electro-optic element was prepared.

Refractive index modulation was observed under the application of an electric field to the resulting element according to the method described in Appl. Phys. Lett. Vol. 56, p. 1734, 1990, so that electro-optic effects were recognized.

1. A nonlinear optical element comprising a layer that contains the compound represented by Formula (I): 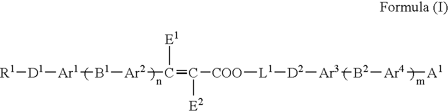
wherein Ar¹, Ar², Ar³, and Ar⁴ each independently represent a five- or six-membered aromatic ring, a five- or six-membered heterocyclic aromatic ring, or a condensed ring thereof, and wherein the rings may have a substituent or substituents; E¹ represents a hydrogen atom or an electron-attracting group; E² represents an electron-attracting group; A¹ represents a hydrogen atom or an electron-attracting group; B¹ and B² each independently represent a single bond, —CH═CH—, —C≡C—, —N═N—, *—COO—, or *—COS—, wherein a bond marked by * is on the left side in Formula (I); m and n each independently represent 1 or 2; D¹ represents an oxygen atom, a sulfur atom or —NR²—; R¹ and R² each independently represent a hydrogen atom or an alkyl group having 1 to 20 carbon atoms and R¹ and R² may be coupled to each other to form a ring; L¹ represents a bivalent linking group; D² represents an oxygen atom, a sulfur atom or —NR³—; R³ represents a hydrogen atom or an alkyl group having 1 to 20 carbon atoms; L¹ and R³ may be coupled to each other to form a ring; and R¹, R², R³, and L¹ may each independently have a substituent or substituents.

2. The nonlinear optical element of claim 1, wherein the electron-attracting group represented by A¹ is —CN, —NO₂, —C═C(CN)₂, —C═C(CN)COO—R⁴, —COO—R⁴, or —SO₂—R⁴, wherein R⁴ represents an alkyl group having 1 to 20 carbon atoms, and the alkyl group may have a hydroxyl group, an amino group, an ester group, an amide group, an ether group, an alkyl group having 1 to 6 carbon atoms, an alkoxy group having 1 to 6 carbon atoms, or a halogen atom.

3. The nonlinear optical element of claim 1, wherein B¹ and B² are each independently a single bond, —C≡C— or —N═N—.

4. The nonlinear optical element of claim 2, wherein B¹ and B² are each independently a single bond, —C≡C— or —N═N—.

5. The nonlinear optical element of claim 1, wherein E² is an electron-attracting group having a sp value of 0.2 to 1.2.

6. The nonlinear optical element of claim 1, wherein E¹ is hydrogen.

7. The nonlinear optical element of claim 2, wherein E¹ is hydrogen.

8. The nonlinear optical element of claim 3, wherein E¹ is hydrogen.

9. The nonlinear optical element of claim 5, wherein E¹ is hydrogen.

10. The nonlinear optical element of claim 1, wherein Ar¹, Ar², Ar³ and Ar⁴ each independently represent a five- or six-membered aromatic ring, a five- or six-membered heterocyclic aromatic ring, or a condensed ring thereof, and wherein the rings are unsubstituted.

11. An electro-optic element comprising a layer that contains the compound represented by Formula (I): 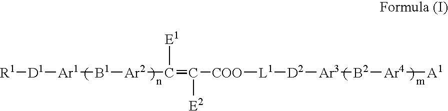
Wherein Ar¹, Ar², Ar³, and Ar⁴ each independently represent a five- or six-membered aromatic ring, a five- or six-membered heterocyclic aromatic ring, or a condensed ring thereof, wherein the rings may have a substituent or substituents; E¹ represents a hydrogen atom or an electron-atttacting group; E² represents an electron-attracting group; A¹ represents a hydrogen atom or an electron-attracting group; B¹ and B² each independently represent a single bond, —CH═CH—, —C≡C—, —N═N—, *—COO—, or *—COS—, wherein a bond marked by * is on the left side in Formula (I); m and n each independently represent 1 or 2; D¹ represents an oxygen atom, a sulfur atom or —NR²—; R¹ and R² each independently represent a hydrogen atom or an alkyl group having 1 to 20 carbon atoms and R¹ and R² may be coupled to each other to form a ring; L¹ represents a bivalent linking group; D² represents an oxygen atom, a sulfur atom or —NR³—; R³ represents a hydrogen atom or an alkyl group having 1 to 20 carbon atoms; L¹ and R³ may be coupled to each other to form a ring; and R¹, R², R³, and L¹ may each independently have a substituent or substituents.

12. The electro-optic element of claim 11, wherein the electron-attracting group represented by A¹ is —CN, —NO₂, —C═C(CN)₂, —C═C(CN)COO—R⁴, —COO—R⁴, or —SO₂—R⁴, wherein R⁴ represents an alkyl group having 1 to 20 carbon atoms, and the alkyl group may have a hydroxyl group, an amino group, an ester group, an amide group, an ether group, an alkyl group having 1 to 6 carbon atoms, an alkoxy group having 1 to 6 carbon atoms, or a halogen atom.

13. The electro-optic element of claim 11, wherein B¹ and B² are each independently a single bond, —C≡C— or —N═N—.

14. The electro-optic element of claim 12, wherein B¹ is and B² are each independently a single bond, —C≡C— or —N═N—.

15. The electro-optic element of claim 11, wherein E² is an electron-attracting group having a sp value of 0.2 to 1.2.

16. The electro-optic element of claim 11, wherein E¹ is hydrogen.

17. The electro-optic element of claim 12, wherein E¹ is hydrogen.

18. The electro-optic element of claim 13, wherein E¹ is hydrogen.

19. The electro-optic element of claim 15, wherein E¹ is hydrogen.

20. The electro-optic element of claim 11, wherein Ar¹, Ar², Ar³ and Ar⁴ each independently represent a five- or six-membered aromatic ring, a five- or six-membered heterocyclic aromatic ring, or a condensed ring thereof, and wherein the rings are unsubstituted.

21. A compound represented by Formula (II): 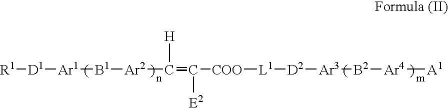
wherein Ar¹, Ar², Ar³, and Ar⁴ each independently represent a five- or six-membered aromatic ring, a five- or six-membered heterocyclic aromatic ring, or a condensed ring thereof, wherein the rings may have a substituent or substituents; E² represents an electron-attracting group having a σp value of 0.2 to 1.2; A¹ represents a hydrogen atom or an electron-attracting group having a σp value of 0.2 to 1.2; B¹ and B² each independently represent a single bond, —CH═CH—, —C≡C—, —N═N—, *—COO—, or *—COS—, wherein a bond marked by * is on the left side in Formula (II); m and n each independently represent 1 or 2; D¹ represents an oxygen atom, a sulfur atom or —NR²—; R¹ and R² each independently represent a hydrogen atom or an alkyl group having 1 to 20 carbon atoms and R¹ and R² may be coupled to each other to form a ring; L¹ represents an alkylene group having 1 to 20 carbon atoms; D² represents an oxygen atom, a sulfur atom or —NR³—; R³ represents a hydrogen atom or an alkyl group having 1 to 20 carbon atoms; L¹ and R³ may be coupled to each other to form a ring; and R¹, R², R³, and L¹ may each independently have a substituent or substituents.

22. The compound of claim 21, wherein the compound represented by Formula (II) is also represented by the following Formula (III): 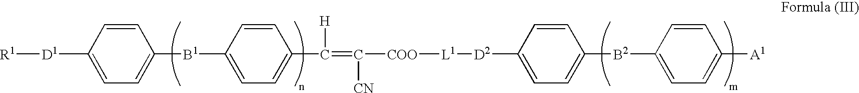
wherein A¹ has the same meaning as defined in Formula (II); the four benzene rings may have a substituent or substituents, wherein the substituents on the benzene rings may be the same or different; and B¹, B², m, n, R¹, R², L¹, D¹, and D² each have the same meaning as defined in Formula (II).

23. The compound of claim 21, wherein the electron-attracting group represented by A¹ is —CN, —NO₂, —C═C(CN)₂, —C═C(CN)COO—R⁴, —COO—R⁴, or —SO₂—R⁴, wherein R⁴ represents an alkyl group having 1 to 20 carbon atoms, and the alkyl group may have a hydroxyl group, an amino group, an ester group, an amide group, an ether group, an alkyl group having 1 to 6 carbon atoms, an alkoxy group having 1 to 6 carbon atoms, or a halogen atom.

24. The compound of claim 22, wherein the electron-attracting group represented by A¹ is —CN, —NO₂, —C═C(CN)₂, —C═C(CN)COO—R⁴, —COO—R⁴, or —SO₂—R⁴, wherein R⁴ represents an alkyl group having 1 to 20 carbon atoms, and the alkyl group may have a hydroxyl group, an amino group, an ester group, an amide group, an ether group, an alkyl group having 1 to 6 carbon atoms, an alkoxy group having 1 to 6 carbon atoms, or a halogen atom.

25. The compound of claim 21, wherein B¹ and B² are each independently a single bond, —C≡C— or —N═N—.

26. The compound of claim 22, wherein B¹ and B² are each independently a single bond, —C≡C— or —N═N—.

27. The compound of claim 21, wherein Ar¹, Ar², Ar³ and Ar⁴ each independently represent a five- or six-membered aromatic ring, a five- or six-membered heterocyclic aromatic ring, or a condensed ring thereof, and wherein the rings are unsubstituted.
